(19) United States
(12) Patent Application Publication
(10) Pub. No.: US 2002/0039420 A1
(43) Pub. Date: Apr. 4, 2002

(54) Method and apparatus for batched network security protection server performance

(76) Inventors: Hovav Shacham, Palo Alto, CA (US); Dan Boneh, Palo Alto, CA (US); Sanjay Beri, Palo Alto, CA (US)

Correspondence Address: WILSON SONSINI GOODRICH & ROSATI, 650 PAGE MILL ROAD, PALO ALTO, CA, 943041050

(21) Appl. No.: 09/877,302

(22) Filed: Jun. 8, 2001

Related U.S. Application Data
(60) Provisional application No. 60/211,023, filed on Jun. 12, 2000.
(60) Provisional application No. 60/211,031, filed on Jun. 12, 2000.

(51) Int. Cl. H04L 9/00

(52) U.S. Cl. 380/277; 713/151

(57) ABSTRACT

A method and system for efficiently conducting secure communications in a commuter network are provided. Secure communications in a network are typically of the Secure Socket Layer (“SSL”) and Transport Layer Security (“TLS”) formats. These formats require the server to decrypt numerous encrypted messages at the cost of efficiency and speed. By combining the encrypted messages into a batch and utilizing a Rivest-Shamir-Adleman (“RSA”) batch decryption algorithm, the efficiency of the decryption is improved. Methods for improving this process include replacing the required number of divisions and inversion with more efficient multiplication operations. Further computation savings are realized by reducing the number of exponentiations and structuring the batches of encrypted messages to contain balanced exponents.

### RELATED APPLICATIONS

This application claims the benefit of U.S. Provisional Application No. 60/211,023 filed Jun. 12, 2000, and Application No. 60/211,031, filed Jun. 12, 2000, both of which are incorporated herein by reference.

### FIELD OF THE INVENTION

The claimed invention relates to the field of secure communications. More particularly it relates to improving the efficiency of establishing secure network communications.

### BACKGROUND OF THE INVENTION

Many network transactions require secure communications. The Secure Socket Layer (“SSL”) is the most widely deployed protocol for securing communication on the World Wide Web (“WWW”). SSL along with other protocols such as Transport Layer Security (“TLS”) are used by E-commerce and financial web sites to guarantee privacy and authenticity of information exchanged between a web server and a web browser. Currently, the number of web sites using SSL and TLS to secure web traffic is growing at a phenomenal rate and as the services provided on the World Wide Web continue to expand so will the need to establish secure connections.

Unfortunately, SSL and TLS are not cheap. A number of studies show that web servers using these protocols perform far worse than web servers that do not encrypt web traffic. In particular, a web server using SSL can handle 30 to 50 times fewer transactions per second than a web server using clear-text communication only. The exact transaction performance degradation depends on the type of web server used by the site and the security protocol implemented. To overcome this degradation web sites typically buy significantly more hardware in order to provide a reasonable response time to their customers.

Web sites often use one of two techniques to overcome secure communication's impact on performance. The first method, as indicated above, is to deploy more machines at the web site and load balance connections across these machines. This is problematic since more machines are harder to administer. In addition, mean time between failures decreases significantly. The other solution is to install a hardware acceleration card inside the web server. The card handles most of the secure network workload thus enabling the web server to focus on its regular tasks. Accelerator cards are available from a number of vendors and while these cards reduce the penalty of using secure connections, they are relatively expensive and are non-trivial to configure. Thus there is a need to establish secure communications on a network at a lower cost.

### SUMMARY OF THE INVENTION

A method and apparatus for batching secure communications in a computer network are provided. When a web browser first connects to a web server using secure protocols, the browser and server execute an initial handshake protocol. The outcome of this protocol is a session encryption key and a session integrity key. These keys are only known to the web server and web browser, and establish a secure session.

Once session keys are established, the browser and server begin exchanging data. The data is encrypted using the session encryption key and protected from tampering using the session integrity key. When the browser and server are done exchanging data the connection between them is closed.

The establishment of a secure session using a protocol such as Secure Socket Layer (“SSL”) begins when the web browser connects to the web server and sends a client-hello message. Soon after receiving the message, the web server responds with a server-hello message. This message contains the server's public key certificate that informs the client of the server's Rivest-Shamir-Adleman algorithm (“RSA”) public key. Having received the public key, the browser picks a random 48-byte string, R, and encrypts it using the key. Letting C be the resulting cipher-text of the string R, the web browser then sends a client-key-exchange message containing C. The 48-byte string R is called the pre-master-secret. Upon receiving the message, from the browser, the web server uses its RSA private key to decrypt C and thus learns R. Both the browser and server then use R and some other common information to derive the session keys. With the session keys established, encrypted message can be sent between the browser and server with impunity.

The decryption of the encrypted string, R, is the expensive part of the initial handshake. An RSA public key is made of two integers [symbol] N, e [symbol] . In an embodiment N=pq is the product of two large primes and is typically 1024 bits long. The value e is called the encryption exponent and is typically some small number such as e=65537. Both N and e are embedded in the server's public key certificate. The RSA private key is simply an integer d satisfying e·d=1 mod (p−1) (q−1). Given an RSA cipher-text C, the web server decrypts C by using its private key to compute C^{d} mod N that reveals the plain-text message, R. Since both d and N are large numbers (each 1024 bits long) this computation takes some effort.

At a later time, the browser may reconnect to the same web server. When this happens the browser and server execute the SSL resume handshake protocol. This protocol causes both server and browser to reuse the session keys established during the initial handshake saving invaluable resources. All application data is then encrypted and protected using the previously established session keys.

Of the three phases, the initial handshake is often the reason why SSL degrades web server performance. During this initial handshake the server performs an RSA decryption or an RSA signature generation. Both operations are relatively expensive and the high cost of the initial handshake is the main reason for supporting the resume handshake protocol. The resume handshake protocol tries to alleviate the cost of the initial handshake by reusing previously negotiated keys across multiple connections. However, in the web environment, where new users constantly connect to the web server, the expensive initial handshake must be executed over and over again at a high frequency. Hence, the need for reducing the cost of the initial handshake protocol.

One embodiment presents an implementation of batch RSA in an SSL web server while other embodiments present substantial improvements to the basic batch RSA decryption algorithms. These embodiments show how to reduce the number of inversions in the batch tree to a single inversion. Another embodiment further speeds up the process by proper use of the Chinese Remainder Theorem (“CRT”) and simultaneous multiple exponentiation.

A different embodiment entails an architecture for building a batching SSL web server. The architecture in this embodiment is based on using a batching server process that functions as a fast decryption oracle for the main web server processes. The batching server process includes a scheduling algorithm to determine which subset of pending requests to batch.

Yet other embodiments improve the performance of establishing secure connections by reducing the handshake work on the server per connection. One technique supports web browsers that deal with a large encryption exponent in the server's certificate, while another approach supports any browser.

### BRIEF DESCRIPTION OF THE DRAWINGS

The present invention is illustrated by way of example in the following figures in which like references indicate similar elements. The following figures disclose various embodiments of the claimed invention for purposes of illustration only and are not intended to limit the scope of the claimed invention.

FIG. 1 is a flow diagram of the initial handshake between a web server and a client of an embodiment.

FIG. 2 is a block diagram of an embodiment of a network system for improving secure communications.

FIG. 3 is a flow diagram for managing multiple certificates using a batching architecture of an embodiment.

FIG. 4 is a flow diagram of batching encrypted messages prior to decryption in an embodiment.

FIG. 5 is a flow diagram for increasing efficiency of the initial handshake process by utilizing cheap keys in an embodiment.

FIG. 6 is a flow diagram for increasing efficiency of the initial encryption handshake by utilizing square keys in an embodiment.

### DETAILED DESCRIPTION

The establishment of a secure connection between a server and a browser can be improved by batching the initial handshakes on the web server. In one embodiment the web server waits until it receives b handshake requests from b different clients. It treats these b handshakes as a batch, or set of handshakes, and performs the necessary computations for all b handshakes at once. Results show that, for b=4, batching the Secure Socket Layer (“SSL”) handshakes in this way results in a factor of 2.5 speedup over doing the b handshakes sequentially, without requiring any additional hardware. While the Secure Socket Layer protocol is a widely utilized technique for establishing a secure network connection, it should be understood that the techniques described herein can be applied to the establishment of any secure network-based connection using any of a number protocols.

One embodiment improves upon a technique developed by Fiat for batch RSA decryption. Fiat suggested that decrypting multiple RSA cipher-texts as a batch would be faster than decrypting them one by one. Unfortunately, experiments show that Fiat's basic algorithm, naively implemented, does not give much improvement for key sizes commonly used in SSL and other network security protection handshakes.

A batching web server must manage multiple public key certificates. Consequently, a batching web server must employ a scheduling algorithm that assigns certificates to incoming connections, and picks batches from pending requests, so as to optimize server performance.

To encrypt a message Musing an RSA public key [symbol] N, e [symbol] , the message M is formatted to obtain an integer X in {1, . . , N}. This formatting is often done using the PKCS1 standard. The cipher-text is then computed as C=X^{e} mod N. This process occurs during the initial stages of the initial handshake between a client and server when attempting to create a secure connection.

To decrypt a cipher-text C the web server uses its private key d to compute the e′th root of C in Z_{N}. The e^{th} root of C is given by C^{d} mod N as previously noted. Since both d and N are large numbers (each 1024 bits long) this is a lengthy computation on the web server. It is noted that d must be taken as a large number (i.e., on the order of N) since otherwise the RSA system is insecure.

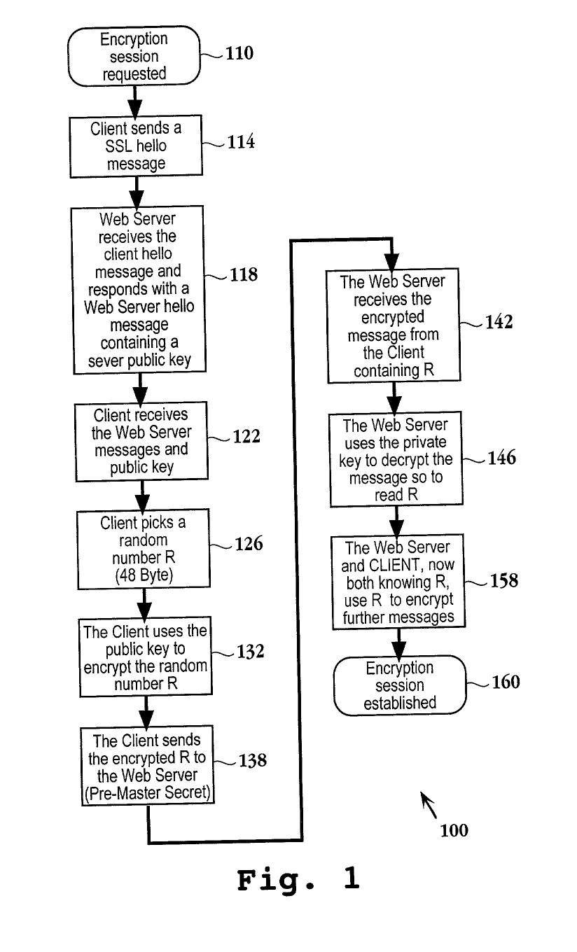

The general process in establishing a Secure Socket Layer communication between a browser or client and a server or host is depicted in FIG. 1. The process begins with a request from the browser to establish a secure session 110. The client forms a hello message requesting a public key and transmits the message to the server 114. Upon receiving the client-hello message, the web server responds with a server-hello message containing a public key 118. The public key is one half of a public/private key pair. While the server transmits the public key back to the browser the server keeps the private key. Once the client receives the public key 122 a random number R is generated 126. This random number is the session key. The client encrypts R by using the private key that it received from the server 132. With the number R encrypted, the client sends the cipher-text to the web-server 138. Upon receiving the cipher-text 142 the web server user the private key portion of the public/private key pair to decrypt the cipher-text 146. With both the client and the server possessing the session key R, a new encrypted secure socket layer session 160 is established using R as the session key 158. This session is truly encrypted since only the client and the web server possess the session key for encryption and decryption.

When using small public exponents, e₁ and e₂, which are components of the public key, it is possible to decrypt two cipher-texts for approximately the price of one. Suppose v₁ is a cipher-text obtained by encrypting using the public key [symbol] N, 3 [symbol] . Similarly, imagine v₂ is a cipher-text obtained by encrypting using the public key [symbol] N, 5 [symbol] . To decrypt v₁ and v₂, computing v₁^{⅓} and v₁^{⅕} mod N are made by setting A=(v₁⁵·V₂³)^{1/15} it can be shown that

$${v}_{1}^{1 / 3} = \frac{{A}^{10}}{{v}_{1}^{3} \cdot {v}_{2}^{2}} and {v}_{2}^{1 / 5} = \frac{{A}^{6}}{{v}_{1}^{2} \cdot {v}_{2}} .$$

Hence, at the cost of computing a single 15^{th} root both v₁ and v₂ can be decrypted.

This batching technique is most useful when the public exponents e₁ and e₂ are very small (e.g., 3 and 5). Otherwise, the extra arithmetic required can be expensive. Also, only cipher-texts encrypted using distinct public exponents can be batch decrypted. Indeed, it can be shown that it is not possible to batch when the same public key is used. That is, it is not possible to batch the computation of v₁^{⅓} and v₂^{⅓}.

This observation to the decryption of a batch of b RSA cipher-texts can be generalized. In one embodiment there are b distinct and pairwise relatively prime public keys e₁, . . . , e_{b}, all sharing a common modulus N=pq. Furthermore, assume there are b encrypted messages, v₁, . . ., V_{b} one encrypted with each key, that are desirable to decrypt simultaneously, to obtain the plain-texts mᵢ=vᵢ^{1/e}^{ᵢ}.

The batch process is implemented around a complete binary tree with b leaves, possessing the additional property that every inner node has two children. In one embodiment the notation is biased towards expressing locally recursive algorithms: Values are percolated up and down the tree. With one exception, quantities subscripted by L or R refer to the corresponding value of the left or right child of the node, respectively. For example, m is the value of m at a node; m_{R} is the value of m at that node's right child and so forth.

Certain values necessary to batching depend on the particular placement of keys in the tree and may be pre-computed and reused for multiple batches. Pre-computed values in the batch tree are denoted with capital letters, and values that are computed in a particular decryption are denoted with lower-case letters.

The batching algorithm consists of three phases: an upward-percolation phase, an exponentiation phase, and a downward-percolation phase. In the upward-percolation phase, the individual encrypted messages vᵢ are combined to form, at the root of the batch tree, the value

$$v = {\prod }_{i = 1}^{b} {v}_{i}^{e / {e}_{i}} , where e = {\prod }_{i = 1}^{b} {e}_{i} .$$

In preparation, assign to each leaf node a public exponent: E←eᵢ. Each inner node then has its E computed as the product of those of its children: E←E_{L}·E_{R}. The root node's E will be equal to e, the product of all the public exponents. Each encrypted message vᵢ is placed (as v) in the leaf node labeled with its corresponding eᵢ. The v's are percolated up the tree using the following recursive step, applied at each inner node:

v←v_{L}^{E}^{_{R}}·v_{R}^{E}^{_{L}}.

At the completion of the upward-percolation phase, the root node contains

$$v = {\prod }_{i = 1}^{b} {v}_{i}^{e / {e}_{i}} .$$

In the exponentiation phase, the e^{th} root of this v is extracted. Here, the knowledge of factorization of N is required. The exponentiation yields

$${v}^{1 / e} = {\prod }_{i = 1}^{b} {v}_{i}^{1 / {e}_{i}} ,$$

which is stored as m in the root node.

In the downward-percolation phase, the intent is to break up the product m into its constituent subproducts m_{L} and m_{R}, and, eventually, into the decrypted messages mᵢ at the leaves. At each inner node an X is chosen satisfying the following simultaneous congruencies:

X=0 (mod E_{L})

X=1 (mod E_{R}).

The value X is constructed using the Chinese Remainder Theorem (“CRT”). Two further numbers, X_{L} and X_{R}, are defined at each node as follows:

X_{L}=X/E_{L} X_{R}=(X−1)/E_{R}.

Both divisions are done over the integers. (There is a slight infelicity in the naming here: X_{L} and X_{R} are not the same as the X's of the node's left and right children, as implied by the use of the L and R subscripts, but separate values.)

The values of X, X_{L}, and X_{R} are such that, at each inner node, m^{X} equals V_{L}^{X}^{_{L·V}}_{R}^{X}^{_{R·m}}_{R}. This immediately suggests the recursive step used in downward-percolation:

$${m}_{R} ← {m}^{X} / ( {v}_{L}^{{X}_{L}} \cdot {v}_{R}^{{X}_{R}} ) {m}_{L} ← m / {m}_{R} \cdot$$

At the end of the downward-percolation process, each leaf's m contains the decryption of the v placed there originally. Only one large (full-size) exponentiation is needed, instead of b of them. In addition, the process requires a total of 4 small exponentiations, 2 inversions, and 4 multiplications at each of the b−1 inner nodes.

Basic batch RSA is fast with very large moduli, but may not provide a significant speed improvement for common sized moduli. This is because batching is essentially a tradeoff. Batching produces more auxiliary operations in exchange for fewer full-strength exponentiations.

Batching in an SSL-enabled web server focuses on key sizes generally employed on the web, e.g., n=1024 bits. Furthermore, this embodiment also limits the batch size b to small numbers, on the order of b=4, since collecting large batches can introduce unacceptable delay. For simplicity of analysis and implementation, the values of b are restricted to powers of 2.

Previous schemes perform two divisions at each internal node, for a total of 2b−2 required modular inversions. Modular inversions are asymptotically faster than large modular exponentiations. In practice, however, modular inversions are costly. Indeed, the first implementation (with b=4 and a 1024-bit modulus) spends more time doing the inversions than doing the large exponentiation at the root. Two embodiments, when combined, require only a single modular inversion throughout the algorithm with the cost of an additional O(b) modular multiplication. This tradeoff gives a substantial running-time improvement.

The first embodiment is referred to herein as delayed division. An important realization about the downward-percolation phase is that the actual value of m for the internal nodes of the tree is consulted only for calculating m_{L} and m_{R}. An alternative representation of m that supports the calculation of m_{L} and m_{R}, and that can be evaluated at the leaves to yield m would do just as well.

This embodiment converts a modular division a/b to a “promise,” [symbol] a, b [symbol] . This promise can operate as though it were a number, and, can “force” getting its value by actually computing b⁻¹a. Operations on these promises work in a way similar to operations in projective coordinates as follows:

$$\begin{matrix} a / b = ⟨ a , b ⟩ & {⟨ a , b ⟩}^{c} = ⟨ {a}^{c} , {b}^{c} ⟩ \\ c \cdot ⟨ a , b ⟩ = ⟨ a c , b ⟩ & ⟨ a , b ⟩ \cdot ⟨ c , d ⟩ = ⟨ a c , b d ⟩ \\ ⟨ a , b ⟩ / c = ⟨ a , b c ⟩ & ⟨ a , b ⟩ / ⟨ c , d ⟩ = ⟨ a d , b c ⟩ .\end{matrix}$$

Multiplication and exponentiation takes twice as much work had these promises not been utilized, but division can be computed without resort to modular inversion.

If, after the exponentiation at the root, the root m is expressed as a promise, m← [symbol] m, 1 [symbol] , this embodiment can easily convert the downward-percolation step to employ promises:

$${m}_{R} ← {m}^{X} / ( {v}_{L}^{{X}_{L}} \cdot {v}_{R}^{{X}_{R}} ) {m}_{L} ← m / {m}_{R} \cdot$$

No internal inversions are required. The promises can be evaluated at the leaves to yield the decrypted messages.

Batching with promises uses b−1 additional small exponentiations and b−1 additional multiplications. This translates to one exponentiation and one multiplication at every inner node, saving 2(b−1)−b=b−2 inversions. To further reduce the number of inversions, another embodiment uses batched divisions. When using delayed inversions one division is needed for every leaf of the batch tree. In the embodiment using batched divisions, these b divisions can be done at the cost of a single inversion with a few more multiplications.

As an example of this embodiment, invert three values x, y, and z. Continue by forming the partial product yz, xz, and xy and then form the total product xyz and invert it, yielding (xyz)⁻¹. With these values, calculate all the inverses:

$${x}^{- 1} = ( y z ) \cdot {( x y z )}^{- 1}$$

$${y}^{- 1} = ( x z ) \cdot {( x y z )}^{- 1}$$

$${z}^{- 1} = ( x y ) \cdot {( x y z )}^{- 1} .$$

Thus the inverses of all three numbers are obtained at the cost of only a single modular inverse along with a number of multiplications. More generally, it can be shown that by letting x₁, . . . , xₙεZ_{N}, all n inverses x₁⁻¹, . . . , xₙ⁻¹ can be obtained at the cost of one inversion and 3n−3 multiplications.

It can be proven that a general batched-inversion algorithm proceeds in three phases. First, set A₁←x₁, and Aᵢ←xᵢ·Aᵢ₋₁ for i>1. By induction, it can be shown that

$${A}_{i} = {\prod }_{j = 1}^{i} {x}_{j} .$$

Next, invert

$${A}_{n} = \prod {x}_{j} ,$$

and store the result in

$${B}_{n} : {B}_{n} ← {( {A}_{n} )}^{- 1} = \prod {x}_{j}^{- 1} .$$

Now, set Bᵢ←xᵢ₊₁·Bᵢ₊₁ for i<n. Again, it can be shown that

$${B}_{i} = {\prod }_{j = 1}^{i} {x}_{j}^{- 1} .$$

Finally, set C₁←B₁, and Cᵢ←Aᵢ₋₁·Bᵢ for i>1. Furthermore, C₁=B₁=x₁⁻¹, and, by combining, Cᵢ=Aᵢ₊₁·Bᵢ=xᵢ⁻¹ for i>1. This embodiment has thus inverted each xᵢ.

Each phase above requires n−1 multiplications, since one of the n values is available without recourse to multiplication in each phase. Therefore, the entire algorithm computes the inverses of all the inputs in 3n−3 multiplications and a single inversion.

In another embodiment batched division can be combined with delayed division, wherein promises at the leaves of the batch tree are evaluated using batched division. Consequently, only a single modular inversion is required for the entire batching procedure. Note that the batch division algorithm can be easily modified to conserve memory and store only n intermediate values at any given time.

The Chinese Remainder Theorem is typically used in calculating RSA decryptions. Rather than computing m←v^{d} (mod N), the modulo p and q is evaluated:

mₚ←vₚ^{d}^{ₚ} (mod p)

m_{q}←Vₚ^{d}^{_{q}} (mod q).

Here dₚ=d mod p−1 and d_{q}=d mod q−1. Correspondingly the CRT can calculate m from mₚ and m_{q}. This is approximately 4 times faster than evaluating m directly.

This idea extends naturally to batch decryption. In one embodiment each encrypted message vᵢ modulo p and q is reduced. Then, instead of using a single batch tree modulo N, two separate, parallel batch trees, modulo p and q, are used and then combined to the final answers from both using the CRT. Batching in each tree takes between a quarter and an eighth as long as in the original, unified tree since the number-theoretical primitives employed, as commonly implemented, take quadratic or cubic time in the bit-length of the modulus. Furthermore, the b CRT steps required to calculate each mᵢ mod N afterwards take negligible time compared to the accrued savings.

Another embodiment referred to herein as Simultaneous Multiple Exponentiation provides a method for calculating a^{u}·b^{v} mod m without first evaluating a^{u}·b^{v}. It requires approximately as many multiplications as does a single exponentiation with the larger of u or v as an exponent.

For example, in the percolate-upward step, V←V_{L}^{E}^{_{R}}·V_{R}^{E}^{_{L}}, the entire right-hand side can be computed in a single multi-exponentiation. The percolate-downward step involves the calculation of the quantity v_{L}^{X}^{_{L}}·v_{R}^{X}^{_{R}}, which can be accelerated similarly. These small-exponentiations-and-product calculations are a larger part of the extra bookkeeping work required for batching. Using Simultaneous Multiple Exponentiation reduces the time required to perform them by close to 50% by combining the exponentiation process.

Yet another embodiment involves Node Reordering. Normally there are two factors that determine performance for a particular batch of keys. First, smaller encryption exponents are better. The number of multiplications required for evaluating a small exponentiation is proportional to the number of bits in the exponent. Since upward and downward percolation both use O(b) small exponentiations, increasing the value of e=Πeᵢ can have a drastic effect on the efficiency of batching.

Second, some exponents work well together. In particular, the number of multiplications required for a Simultaneous Multiple Exponentiation is proportional to the number of bits in the larger of the two exponents. If batch trees are built that have balanced exponents for multiple exponentiation (E_{L} and E_{R}, then X_{L} and X_{R}, at each inner node), the multi-exponentiation phases can be streamlined.

With b=4, optimal reordering is fairly simple. Given public exponents e₁<e₂<e₃<e₄, the arrangement e₁−e₄−e₂−e₃ minimizes the disparity between the exponents used in Simultaneous Multiple Exponentiation in both upward and downward percolation. Rearranging is harder for b>4.

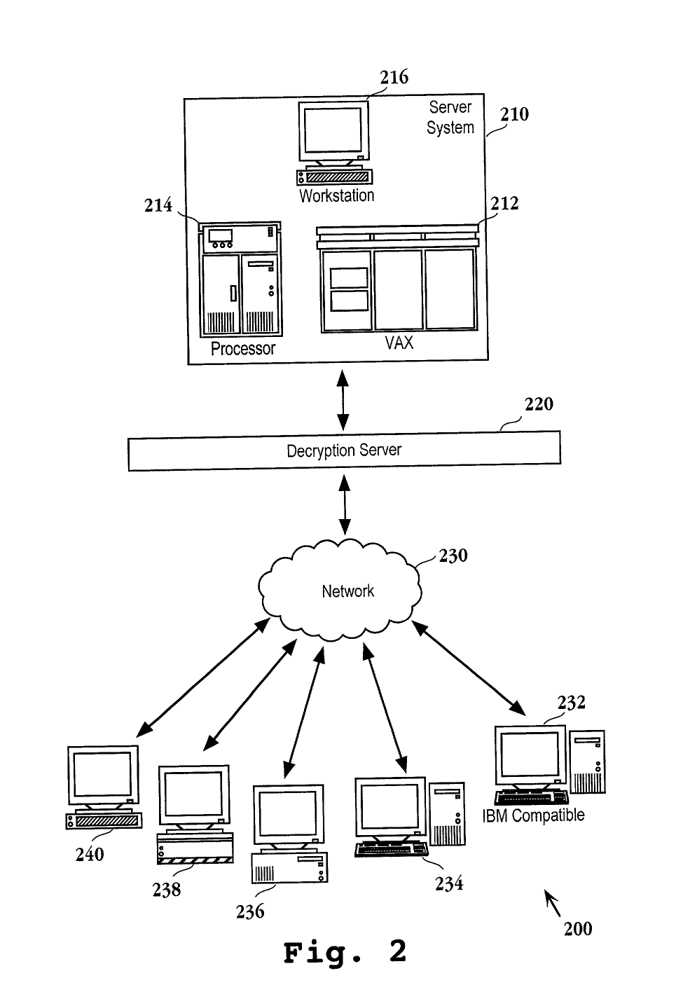

FIG. 2 is an embodiment of a system 200 for improving secure communications. The system includes multiple client computers 232, 234, 236, 238 and 240 which are coupled to a server system 210 through a network 230. The network 230 can be any network, such as a local area network, a wide area network, or the Internet. Coupled among the server system 210 and the network 230 is a decryption server. While illustrated as a separate entity in FIG. 2, the decryption server can be located independent of the server system or in the environment or among any number of server sites 212, 214 and 216. The client computers each include one or more processors and one or more storage devices. Each of the client computers also includes a display device, and one or more input devices. All of the storage devices store various data and software programs. In one embodiment, the method for improving secure communications is carried out on the system 200 by software instructions executing on one or more of the client computers 232-240. The software instructions may be stored on the server system 210 any one of the server sites 212-216 or on any one of the client computers 232-240. For example, one embodiment presents a hosted application where an enterprise requires secure communications with the server. The software instructions to enable the communication are stored on the server and accessed through the network by a client computer operator of the enterprise. In other embodiments, the software instructions may be stored and executed on the client computer. A user of the client computer with the help of a user interface can enter data required for the execution of the software instructions. Data required for the execution of the software instructions can also be accessed via the network and can be stored anywhere on the network.

Building the batch RSA algorithm into real-world systems presents a number of architectural challenges. Batching, by its very nature, requires an aggregation of requests. Unfortunately, commonly-deployed protocols and programs are not designed with RSA aggregation in mind. The solution in one embodiment is to create a batching server process that provides its clients with a decryption oracle, abstracting away the details of the batching procedure.

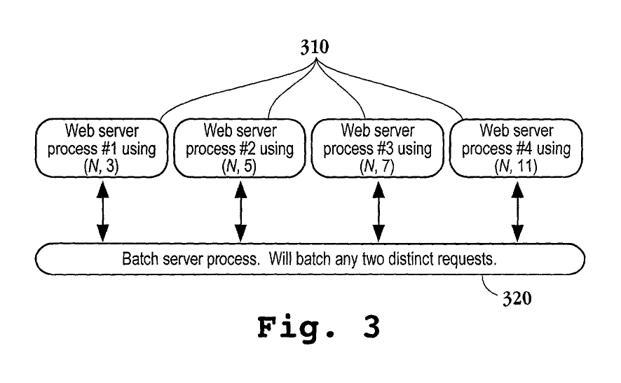

With this approach modifications to the existing servers are minimized. Moreover, it is possible to simplify the architecture of the batch server itself by freeing it from the vagaries of the SSL protocol. An example of the resulting web server design is shown in FIG. 3. Note that in batching the web server manages multiple certificates, i.e., multiple public keys, all sharing a common modulus N 310.

One embodiment for managing multiple certificates is the two-tier model. For a protocol that calls for public-key decryption, the presence of a batch-decryption server 320 induces a two-tier model. First is the batch server process that aggregates and performs RSA decryptions. Next are client processes that send decryption requests to the batch server. These client processes implement the higher-level application protocol (e.g., SSL) and interact with end-user agents (e.g., browsers).

Hiding the workings of the decryption server from its clients means that adding support for batch RSA decryption to existing servers engenders the same changes as adding support for hardware-accelerated decryption. The only additional challenge is in assigning the different public keys to the end-users such that there are roughly equal numbers of decryption requests with each eᵢ. As the end-user response times are highly unpredictable, there is a limit to the flexibility that may be employed in the public key distribution.

If there are k keys each with a corresponding certificate, it is possible to create a web with ck web server processes with a particular key assigned to each. This approach provides that individual server processes need not be aware of the existence of multiple keys. The correct value for c depends on factors such as, but not limited to, the load on the site, the rate at which the batch server can perform decryption, and the latency of the communication with the clients.

Another embodiment accommodates workload unpredictability. The batch server performs a set of related tasks including receiving requests for decryption, each of which is encrypted with a particular public exponent eᵢ. Having received the requests it aggregates these into batches and performs the batch decryption as described herein. Finally, the server responds to the requests for decryption with the corresponding plain-text messages. The first and last of these tasks are relatively simple I/O problems and the decryption stage is discussed herein. What remains is the scheduling step.

One embodiment possesses scheduling criteria including maximum throughput, minimum turnaround time, and minimum turnaround-time variance. The first two criteria are self-evident and the third is described herein. Lower turnaround-time variance means the server's behavior is more consistent and predictable which helps prevent client timeouts. It also tends to prevent starvation of requests, which is a danger under more exotic scheduling policies.

Under these constraints a batch server's scheduling can implement a queue where older requests are handled first. At each step the server seeks the batch that allows it to service the oldest outstanding requests. It is impossible to compute a batch that includes more than one request encrypted with any particular public exponent eᵢ. This immediately leads to the central realization about batch scheduling that it makes no sense, in a batch, to service a request that is not the oldest for a particular eᵢ. However, substituting the oldest request for a key into the batch improves the overall turnaround-time variance and makes the batch server better approximate a perfect queue.

Therefore, in choosing a batch, this embodiment needs only consider the oldest pending request for each eᵢ. To facilitate this, the batch server keeps k queues Qᵢ, or one for each key. When a request arrives, it is placed onto the queue that corresponds to the key with which it was encrypted. This process takes O(1) time. In choosing a batch, the server examines only the heads of each of the queues.

Suppose that there are k keys, with public exponents e₁, . . . , ek, and that the server decrypts requests in batches of b messages each. The correct requests to batch are the b oldest requests from amongst the k queue heads. If the request queues Qᵢ are kept in a heap with priority determined by the age of the request at the queue head, then batch selection can be accomplished by extracting the maximum, oldest-head, queue from the heap, de-queue the request at its head, and repeat the process to obtain b requests to batch. After the batch has been selected, the b queues from which requests were taken may be replaced in the heap. The entire process takes O(b1gk) time.

Another embodiment utilizes multi-batch scheduling. While the process described above picks only a single batch, it is possible, in some cases, to choose several batches at once. For example, with b=2, k=3, and requests for the keys 3-3-5-7 in the queues, the one-step lookahead may choose to do a 5-7 batch first, after which only the unbatchable 3-3 remain. A smarter server could choose to do 3-5 and 3-7 instead. The algorithms for doing lookahead are more complicated than the single-batch algorithms. Additionally, since they take into account factors other than request age, they can worsen turnaround-time variance or lead to request starvation.

A more fundamental objection to multi-batch lookahead is that performing a batch decryption takes a significant amount of time. Accordingly, if the batch server is under load, additional requests will arrive by the time the first chosen batch has been completed. These can make a better batch available than was without the new requests.

But servers are not always under maximal load. Server design must take different load conditions into account. One embodiment reduces latency in a medium-load environment by using k public keys on the web server and allowing batching of any subset of b of them, for some b<k. To accomplish this the batches must be pre-constructed and the constants associated with

$$( \begin{matrix}k \\ b\end{matrix} )$$

batch trees must be keep in memory one for each set of e's.

However, it is no longer necessary to wait for exactly one request with each e before a batch is possible. For k keys batched b at a time, the expected number of requests required to give a batch is

$$E [ \# requests ] = k \cdot {\sum }_{i = 1}^{b} \frac{1}{k - i + 1} .$$

This equation assumes each incoming request uses one of the k keys randomly and independently. With b=4, moving from k=4 to k=6 drops the expected length of the request queue at which a batch is available by more than 31%, from 8.33 to 5.70.

The particular relationship of b and k can be tuned for a particular server. The batch-selection algorithm described herein is time-performance logarithmic in k, so the limiting factor on k is the size of the k^{th} prime, since particularly large values of e degrade the performance of batching.

In low-load situations, requests trickle in slowly, and waiting for a batch to be available can introduce unacceptable latency. A batch server should have some way of falling back on unbatched RSA decryption, and, conversely, if a batch is available and batching is a better use of processor time than unbatched RSA, the servers should be able to exploit these advantages. So, by the considerations given above, the batch server should perform only a single unbatched decryption, then look for new batching opportunities.

Scheduling the unbatched decryptions introduces some complications. Previous techniques in the prior art provide algorithms that when requests arrive, a batch is accomplished if possible, otherwise a single unbatched decryption is done. This type of protocol leads to undesirable real-world behavior. The batch server tends to exhaust its queue quickly. Furthermore it responds immediately to each new request and never accumulates enough requests to batch.

One embodiment chooses a different approach that does not exhibit the performance degradation associated with the prior art. The server waits for new requests to arrive, with a timeout. When new requests arrive, it adds them to its queues. If a batch is available, it evaluates it. The server falls back on unbatched RSA decryptions only when the request-wait times out. This approach increases the server's turnaround-time under light load, but scales gracefully in heavy use. The timeout value is tunable.

Since modular exponentiation is asymptotically more expensive than the other operations involved in batching, the gain from batching approaches a factor-of-b improvement only when the key size is improbably large. With 1024-bit RSA keys the overhead is relatively high and a naive implementation is slower than unbatched RSA. The improvements described herein lower the overhead and improve performance with small batches and standard key-sizes.

Batching provides a sizeable improvement over plain RSA with b=8 and n=2048. More important, even with standard 1024-bit keys, batching significantly improves performance. With b=4, RSA decryption is accelerated by a factor of 2.6; with b=8, by a factor of almost 3.5. These improvements can be leveraged to improve SSL handshake performance.

At small key sizes, for example n=512, an increase in batch size beyond b=4 provides only a modest improvement in RSA performance. Because of the increased latency that large batch sizes impose on SSL handshakes, especially when the web server is not under high load, large batch sizes are of limited utility for real-world deployment.

SSL handshake performance improvements using batching can be demonstrated by writing a simple web server that responds to SSL handshake requests and simple HTTP requests. The server uses the batching architecture described herein. The web server is a pre-forked server, relying on “thundering herd” behavior for scheduling. All pre-forked server processes contact an additional batching server process for all RSA decryptions as described herein.

Batching increases handshake throughput by a factor of 2.0 to 2.5, depending on the batch size. At better than 200 handshakes per second, the batching web server is competitive with hardware-accelerated SSL web servers, without the need for the expensive hardware.

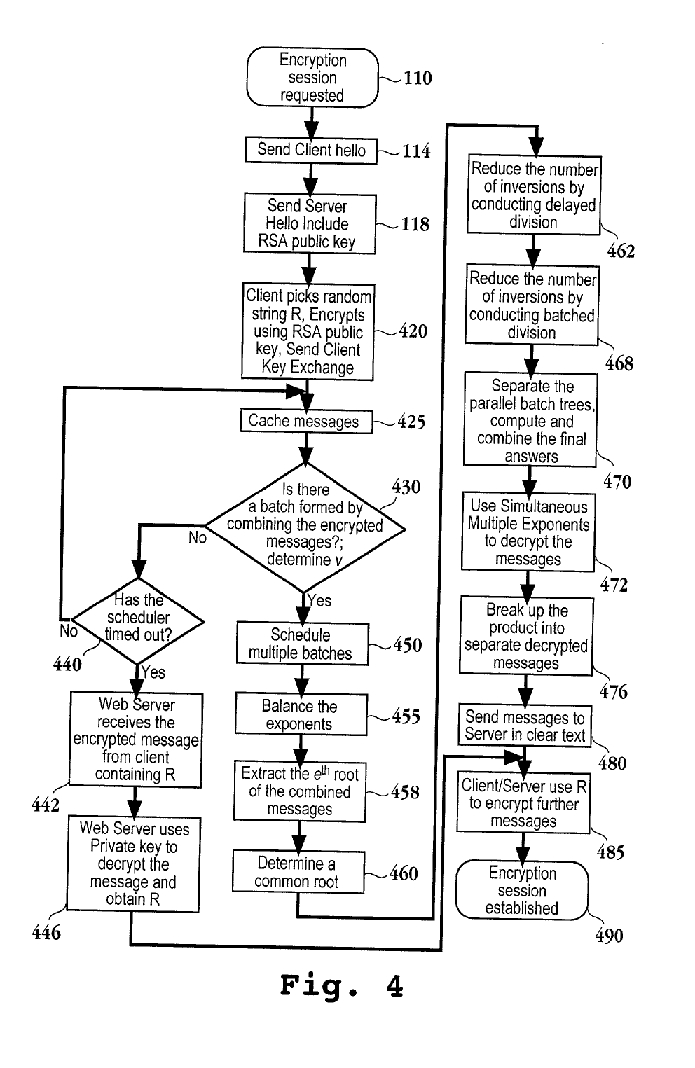

FIG. 4 is a flow diagram for improving secure socket layer communication through batching of an embodiment. As in a typical initial handshake between server and client in establishing a secure connection, the client uses the server's public key to encrypt a random string R and then sends the encrypted R to the server 420. The message is then cached 425 and the batching process begins by determining is there is sufficient encrypted messages coming into the server to form a batch 430. If the answer to that query is no, it is determined if the scheduling algorithm has timed out 440. Again if the answer is no the message returns to be held with other cached messages until a batch has been formed or the scheduler has timed out. If the scheduler has timed out 440 then the web server receives the encrypted message from the client containing R 442. The server then employs the private key of the public/private RSA key pair to decrypt the message and determine R 446. With R determined the client and the server use R to secure further communication 485 and establish an encrypted session 490.

Should enough encrypted messages be available to create a batch 430 the method examines the possibility of scheduling multiple batches 450. With the scheduling complete the exponents of the private key are balanced, 455, and the e^{th} root of the combined messages is extracted 458 allowing a common root to be determined and utilized 460. The embodiment continues by reducing the number of inversions by conducting delayed division 462 and batched division 468. With the divisions completed, separate parallel batch trees are formed to determine the final inversions that are then combined 470. At this point simultaneous multiple exponents are applied to decrypt the messages 472 which are separated 476 and sent to the server in clear text 480. With the server and client both possessing the session key R 485 a encrypted session can be established 490.

Batching increases the efficiency and reduces the cost of decrypting the cipher-text message containing the session's common key. By combining the decryption of several messages in an optimized and time saving manner the server is capable of processing more messages thus increasing bandwidth and improving the over all effectiveness of the network. While the batching techniques described previously are a dramatic improvement in secure socket layer communication, other techniques can also be employed to improve the handshake protocol.

Another embodiment for the improvement to the handshake protocol focuses on how the web server generates its RSA key and how it obtains a certificate for its public key. By altering how the browser uses the server's public key to encrypt a plain-text R, and how the web server uses its private key to decrypt the resulting cipher-text C, this embodiment provides significant improvements to SSL communications.

In one embodiment a server generates an RSA public/private key pair by generating two distinct n-bit primes p and q and computing N=pq. While N can be of any arbitrary size, assume for simplicity that N is 1024 bits long and let w=gcd(p−1, q−1) where gcd is the greatest common divisor. The server then picks two random k-bit values r₁, r₂ such that gcd(r₁, p−1)=1, gcd(r₂, q−1)=1, and r₁=r₂ mod w. Typically k falls in the range of 160-512 bits in size. Although other larger values are also acceptable, k is minimized to enhance performance. The server then computes d such that d=r₁ mod p−1 and d=r₂ mod q−1. Having computed d, e′ is found by solving the equation e′=d⁻¹ mod φ(N) resulting in the public key being [symbol] N, e′ [symbol] and the private key [symbol] r₁, r₂ [symbol] .

The server then sends the public key to a Certificate Authority (CA). The CA returns a public key certificate for this public key even though e′ is very large, namely on the order of N. This is unlike standard RSA public key certificates that use a small value of e, e.g. e=65537. Consequently, the CA must be willing to generate certificates for such keys.

To find d the Chinese Remainder Theorem is typically used. Unfortunately, p−1 and q−1 are not relatively prime (they are both even) and consequently the theorem does not apply. However, by letting w=gcd(p−1, q−1), knowing that

$$\frac{p - 1}{w} and \frac{q - 1}{w}$$

are relatively prime, and recalling that r₁=r₂=a mod w, the CRT can be used to find an element d′ such that

$${d}^{′} = \frac{{r}_{1} - a}{w} ( mod \frac{p - 1}{w} )$$

$${d}^{′} = \frac{{r}_{2} - a}{w} ( mod \frac{q - 1}{w} ) .$$

Observing that the required d is simply d=w·d′+a and indeed, d=r₁ mod p−1 and d=r₂ mod q−1, if w is large, the requirement that r₁=r₂ mod w reduces the entropy of the private key. For this reason it is desirable to ensure that w is small and one embodiment lets w=2, or namely that gcd(p−1, q−1)=2. Recall that gcd(r₁, p−1)=1 and gcd(r₂, q−1)=1. It follows that gcd(d, p−1)=1 and gcd(d, q−1)=1 and consequently gcd(d, (p−1)(q−1))=1. Hence, d is invertible modulo φ(N)=(p−1)(q−1).

The web browser obtains the server's public key certificate from the server-hello message. In this embodiment, the certificate contains the server's public key [symbol] N, e [symbol] . The web browser encrypts the pre-master-secret R using this public key in exactly the same way it encrypts using a normal RSA key. Hence, there is no need to modify any of the browser's software. The only issue is that since e′ is much larger than e in a normal RSA key, the browser must be willing to accept such public keys.

When the web server receives the cipher-text C from the web browser the web server then uses the server's private key, (r₁, r₂), to decrypt C. To accomplish this the server computes R′₁=C^{r}^{₁} mod p and R′₂=C^{r}^{₂} mod q. Using CRT the server then computes an RεZ_{N} such that R=R′₁ mod p and R=R′₂ mod q, noting that R=C^{d} mod N. Hence, the resulting R is a proper decryption of C.

Decryption using a standard RSA public key is completed with Cd mod N using the CRT. Typically R₁=C^{(d mod p-1)} mod p and R₂=C^{(d mod q-}1) q is first computed and then the CRT is applied to R₁, R₂ to obtain R mod N. Note that the exponents d mod p−1 and d mod q−1 are typically as large as p and q, namely 512 bits each. Hence, to generate the signature the server must compute one exponentiation modulo p and one exponentiation modulo q. When N is 1024 bits, the server does two full exponentiations modulo 512-bit numbers.

In one embodiment, the server computes R₁, R₂ and then applies CRT to R₁, R₂. As in normal RSA, the bulk of the work is in computing R′₁, R′₂ However, computing R′₁ requires raising C to the power of r₁, which minimized. Since the time that modular exponentiation takes is linear in time to the size of the exponent, computing R′₁ takes approximately one third the work and one third of the time of raising C to the power of a 512 bit exponent. Hence, computing R′₁ takes one third the work of computing R₁. Therefore, during the entire decryption process the server does approximately one third the work as in a normal SSL handshake.

To illustrate the implementation of this embodiment suppose Eve is an eavesdropper that listens on the network while the handshake protocol is taking place. Eve sees the server's public key [symbol] N, e′ [symbol] and the encrypted pre-master-secret C. Suppose r₁<r₂. It can be shown that an adversary who has [symbol] N, e′ [symbol] , C can mount an attack on the system that runs in time O(\sqrt{r₁}log r)

Let [symbol] N, e′ [symbol] be an RSA public key with N=pq and let dεZ be the corresponding RSA private key satisfying d=r₁, mod p−1 and d=r₂ mod q−1 with r₁<r₂. If r₁ is m bits long and it is assumed that r₁≠r₂ mod 2^{m/2}, then given [symbol] N, e′ [symbol] an adversary can expose the private key d in time O(\sqrt{r₁}log r₁). One skilled in the art knows that e′=(r₁)⁻¹ mod (p−1). But, suppose r₁ is m-bits long. If r₁=A·2^{m/2}+B where A, B are in [0, 2^{m/2}] and a random gεZ_{N} is selected combined with the definition

$$G ( X ) = {\prod }_{i = 0}^{{2}^{m / 2}} ( {g}^{{e}^{′} \cdot {2}^{m / 2} \cdot i} \cdot X - g ) ,$$

then if follows that G(g^{e′·B})=0 mod p. This occurs since one of the products above is

(g^{e′·2}^{^{m/2}}^{·A}·g^{e′·B}−g)=g^{e′r}^{₁}−g=0 (mod p).

Since r₁≠r₂ mod 2^{m/2}, it can be shown that G(g^{e′·B})≠0 mod q. Hence, gcd (N, G(g^{e′·B})) gives a non-trivial factor of N. Hence, if G(x) mod N is evaluated at x=g^{e′·j} for j=0, . . . , 2^{m/2} at least one of the values will expose the factorization of N. Evaluating a polynomial of degree 2^{m/2} at 2^{m/2} values can be done in time 2^{m/2}·m/2 using Fast Fourier Transform methods. This algorithm requires Õ(2^{m/2}) space. Hence, in time at most O(\sqrt{r₁}log r₁) we can factor N. Thus in order to obtain security of 2⁸⁰, both r₁ and r₂ must be at least 160 bits long.

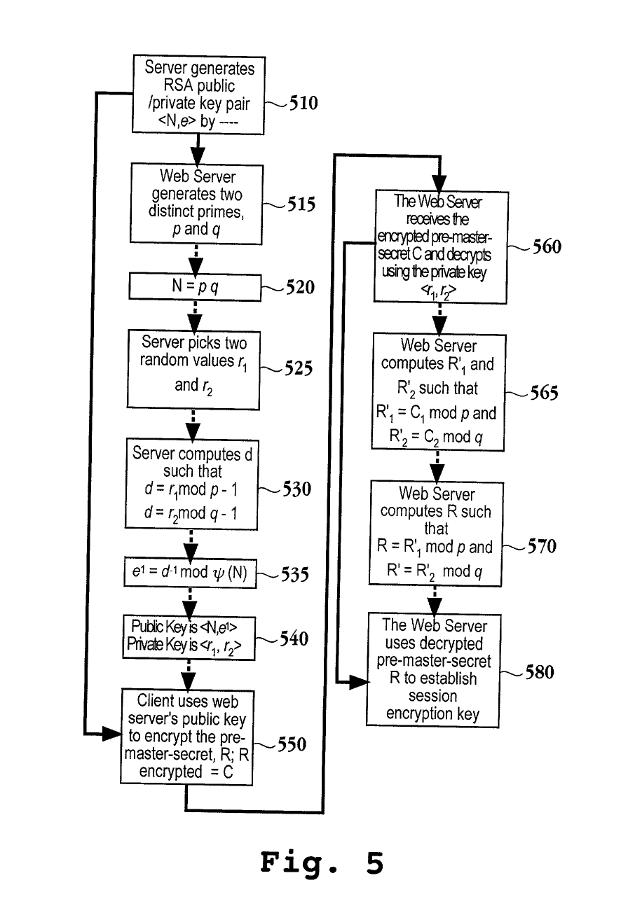

FIG. 5 is a flow diagram for improving secure socket layer communications of an embodiment by altering the public/private key pair. In operation, the server generates an RSA public/private key pair initiating a normal initial handshake protocol 510. At this point the server generates two distinct prime numbers 515 and takes the product of the numbers to produce the N component of the public key 520. Similarly, the server picks two random values to create the private key 525. Using the prime numbers 515 and the random values of the private key 525, the server computes the value d 530 and correspondingly the value el 535. The result is a new public/private key pair 540 that the client uses to encrypt the pre-master-secret R 550. Once R has been encrypted with the new public key and transmitted to the server as cipher-text C, the server uses it private key to decrypt the pre-master-secret 560. Once R₁ and R₂ have been determined 565 they are combined to find R 570. Having the value of the pre-master-secret intact, the server and client can establish a secure session 580.

A further embodiment dealing with the handshake protocol reduces the work per connection on the web server by a factor of two. This embodiment works with all existing browsers. As before, the embodiment is illustrated by describing how the web server generates its RSA key and obtains a certificate for its public key. This embodiment continues in describing how the browser uses the server's public key to encrypt a plain-text R, and the server uses its private key to decrypt the resulting cipher-text C.

In this embodiment the server generates an RSA public/private key pair by generating two distinct n-bit primes p and q such that the size of each distinct prime number is on the order of one third of the size of N. Using this relationship the server computes N′ as N=p²·q. The relationship between the prime numbers and N is dependent on the power by which one of the prime number is raised. For example if one of the prime numbers was raised to the fourth power the prime numbers would be on the order of one fifth the size of N. The exponent of at least one of the prime numbers must be greater than one. While clearly N′ can be of arbitrary size, assume for simplicity that N′ is 1024 bits long, and hence p and q are 341 bits each. The server uses the same e used in standard RSA public keys, namely e=65537 as long as gcd(e, (p−1)(q−1))=1. The server then computes d=e⁻¹ mod (p−1)(q−1) as well as r₁=d mod p−1 and r₂=d mod q−1. With the public key being [symbol] N′, e [symbol] and the private key being (r₁, r₂), the server sends the public key, [symbol] N′, e [symbol] , to a Certificate Authority (CA) and the CA returns a public key certificate. The public key in this case cannot be distinguished from a standard RSA public key.

The web browser obtains the server's public key certificate from the server-hello message. The certificate contains the server's public key [symbol] N′, e [symbol] . The web browser encrypts the pre-master-secret R using this public key in exactly the same way it encrypts using a normal RSA key.

When the web server receives the cipher-text C from the web browser the web server decrypts C by computing R′₁=C^{r}^{₁} mod p and R′₂=C^{r}^{₂} mod q. Note that (R′₁)^{e}=C mod p and (R′₂)^{e}=C mod q. Lifting the server constructs an R″₁ such that (R″₁)^{e}=C mod p². More precisely, the server computes

$${R}_{1}^{″} = {R}_{1}^{′} - \frac{{( {R}_{1}^{′} )}^{e} - C}{e \cdot {( {R}_{1}^{′} )}^{e - 1}} ( mod {p}^{2} ) .$$

Using CRT, the server computes an RεZ_{N} such that R=R″₁ mod p² and R=R′₂ mod q noting that R=C^{d} mod N. Hence, the resulting R is a proper decryption of C. Recall that when N is 1024 bits, the server does two full exponentiations modulo 512-bit numbers.

In this embodiment the server computes R′₁, R′₂, R″₁ and then applies CRT to R″₁, R′₂. The bulk of the work is in computing R′₁, R′₂, R″₁ but computing R′₁ requires a full exponentiation modulo a 341-bit prime rather than a 512-bit prime. The same holds for R′₂. Hence in this embodiment, computing R′₁, R′₂ takes approximately half the time of computing R₁, R₂. Furthermore, computing R″₁ from R′₁ only requires a modular inversion modulo p². This takes little time when compared with the exponentiations for computing R′₁, R′₂. Hence, using this embodiment the handshake takes approximately half the work of a normal handshake on the server.

Some accelerator cards do not provide support for modular inversion. As a result, the inversion is preformed using an exponentiation. This is done by observing that for any xεZ^{*}ₚ the inverse of x is given by:

x⁻¹=x^{p}^{²}^{-p-1} (mod p²).

Unfortunately, using an exponentiation to do the inversion hurts performance. As discussed herein a better embodiment for inversion in this case is batching. One can invert two numbers x₁, x₂εZ^{*}ₚ as a batch faster than inverting the two numbers separately. To do so use the fact that

x₁⁻¹=x₂·(x₁x₂)⁻¹ and x₂⁻¹=x₁·(x₁x₂)⁻¹ (mod p²).

Hence, at the cost of inverting x₁·x₂ it is possible to invert both x₁ and x₂. This embodiment shows that an inversion of k elements x₁, . . . , xₖεZ^{*}ₚ is at the cost of one inversion and k log₂ k multiplications. Thus, the amortized cost of a single inversion is l/k of an exponentiation plus log₂ k multiplications.

To take advantage of batched inversion in the SSL handshake a number of instances of the handshake protocol are collected from among different users and the inversion is preformed on all handshakes as a batch. As a result, the amortized total number of exponentiations per handshake is

$$2 + \frac{1}{k} .$$

This approximately gives a factor of two improvement in the handshake work on the server as compared to the normal handshake protocol.

The security of the improved handshake protocol depends on the difficulty of factoring integers of the form N=p²·q. When 1024 bit keys are used the fastest factoring algorithms (i.e. the number field sieve) cannot take advantage of the special structure of N. Similarly, p and q are well beyond the capabilities of the Elliptic Curve Method (ECM).

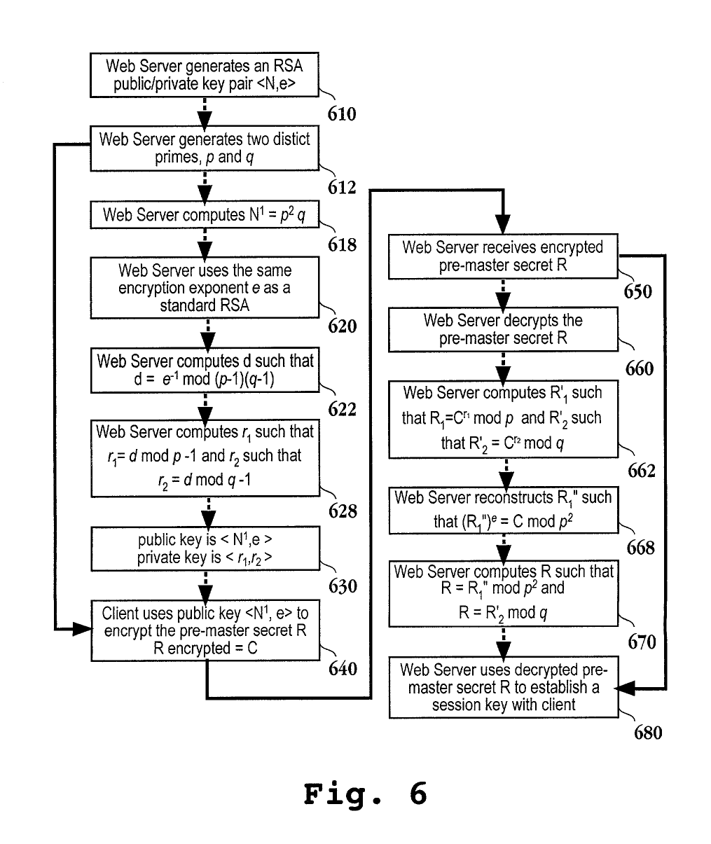

FIG. 6 is a flow diagram for modifying the public key of an embodiment to facilitate an improvement in secure socket layer communication. As in other embodiments, the process begins with the servers generation of a RSA public/private key pair 610. In this embodiment, the public key is modified. The web server generates two distinct prime numbers 612 and computes a new N′ 618. Using the same exponent 620 the server computes the value d 622 which it uses to find the private key 628. The result is a pubic/private key combination 630 that the sever then sends to the client for the encryption of the pre-master-secret 640. Once the server receives the encrypted pre-master-secret, R, from the client 650 the server decrypts R 660 by computing R1 662 and R2 668 and combining the results 670. Once R has been determined the client can establish a secure session with the client using the new session key 680.

From the above description and drawings, it will be understood by those of ordinary skill in the art that the particular embodiments shown and described are for purposes of illustration only and are not intended to limit the scope of the claimed invention.

What is claimed is:

1. A method for secure communications in a computer network, comprising;
combining individually encrypted network security protection handshake messages into a set of encrypted messages wherein each encrypted handshake message is derived using a public key containing an encryption exponent;
determining a root node of a binary tree comprising leaf nodes corresponding to each encryption exponent;
calculating a product of the encrypted messages;
extracting at least one root from the product of the encrypted messages; and
decrypting the encrypted messages by expressing the at least one root as at least one promise and evaluating the at least one promise at the leaf nodes decreasing the number of modular inversions wherein efficiency of the decryption is increased.

2. The method of claim 1, wherein the secure communications include secure socket layer (“SSL”) messages.

3. The method of claim 1, wherein the secure communications include transport layer security (“TLS”) messages.

4. The method of claim 1, wherein the secure communications include internet protocol secure (“IPSec”) techniques.

5. The method of claim 1, wherein evaluating the at least one promise includes multiplying an inversion of a total product of the leaf nodes with a partial product of the leaf nodes to produce the inversion of an individual leaf node.

6. The method of claim 1, further comprising minimizing the disparity among the sizes of the encryption exponents of the public keys within the set.

7. The method of claim 1, wherein determining includes using a plurality of separate, parallel batch trees finding the root node of each tree and combining the final answers.

8. The method of claim 1, wherein decrypting includes simultaneous multiple exponentiation such that the encryption exponents are combined to reduce the number of exponentiations.

9. A method for improving secure communications in a computer network comprising;
combining individually encrypted network security protection handshake messages into a set of encrypted messages wherein each encrypted handshake message is derived using a public key containing an encryption exponent;
determining a root node of a binary tree comprising leaf nodes corresponding to the encryption exponent of each encrypted message;
calculating a product of the encrypted messages;
extracting at least one root from the product of the encrypted messages; and
decrypting the encrypted messages by evaluating at least one individual leaf node by multiplying an inversion of the total product of leaf nodes with a partial product of the leaf nodes to produce an inversion of the at least one individual leaf node wherein efficiency of the decryption is increased.

10. The method of claim 9, wherein the network security protection handshake messages include secure socket layer (“SSL”) messages.

11. The method of claim 9, wherein the network security protection messages include transport layer security (“TLS”) messages.

12. The method of claim 9, wherein the network security protection messages include internet protocol secure (“IPSec”) messages.

13. The method of claim 9, further comprising minimizing the disparity among the sizes of the encryption exponents of the public keys within the set.

14. The method of claim 9, wherein determining includes using a plurality of separate, parallel batch trees finding the root node of each tree and combining the answers.

15. The method of claim 9, wherein decrypting includes simultaneous multiple exponentiation such that the encryption exponents are combined to reduce the number of exponentiations.

16. The method of claim 9, wherein decrypting includes expressing the at least one root as at least one promise and evaluation the at least one promise at the leaf nodes decreasing the number of modular inversions.

17. A method for secure communications in a computer network, comprising;
combining individually encrypted network security protection handshake messages into a set of encrypted messages wherein each encrypted handshake message is derived using a public key containing an encryption exponent;
determining a root node of a binary tree comprising leaf nodes corresponding to the encryption exponent of each encrypted message;
calculating a product of the encrypted messages;
extracting at least one root from the product of the encrypted messages; and
decrypting the encrypted messages by minimizing the disparity between the sizes of the encryption exponents of the public keys, wherein efficiency of the secure communications is increased.

18. The method of claim 17, wherein combining includes secure socket layer (“SSL”) messages.

19. The method of claim 17, wherein combining includes transport layer security (“TLS”) messages.

20. The method of claim 17, wherein combining includes internet protocol secure (“IPSec”) messages.

21. The method of claim 17, wherein determining uses a plurality of separate, parallel batch trees finding the root node of each tree and combining the final answers.

22. The method of claim 17, wherein decrypting includes simultaneous multiple exponentiation such that the encryption exponents are combined to reduce the number of exponentiations.

23. The method of claim 17, wherein decrypting includes expressing the at least one root as at least one promise and evaluating the at least one promise at the leaf nodes decreasing the number of modular inversion.

24. The method of claim 17, wherein decrypting includes evaluating at least one individual leaf node by multiplying an inversion of the total product of leaf nodes with a partial product of the leaf nodes to produce an inversion of the at least one individual leaf node.

25. A method for improving secure communications in a computer network, comprising;
combining individually encrypted network security protection handshake into a set of encrypted messages wherein each encrypted handshake message is derived using a public key containing an encryption exponent;
determining a root node of a binary tree comprising leaf nodes corresponding to each encryption exponent by using a plurality of separate parallel batch trees finding the root node of each tree and combining the final answers;
calculating a product of the encrypted messages;
extracting at least one root from the product of the encrypted messages; and
decrypting the encrypted messages by expressing the at least one root as at least one promise and evaluating the at least one promise at the leaf nodes producing a reduced number of modular inversions wherein efficiency of establishing secure communications is increased.

26. The method of claim 25, wherein combining includes secure socket layer (“SSL”) messages.

27. The method of claim 25, wherein combining includes transport layer security (“TLS”) messages.

28. The method of claim 25, wherein combining includes internet protocol secure (“IPSec”) messages.

29. The method of claim 25, wherein decrypting includes simultaneous multiple exponentiation such that the encryption exponents are combined to reduce the number of exponentiations.

30. The method of claim 25, wherein evaluating the at least one promise includes multiplying an inversion of a total product of the leaf nodes with a partial product of the leaf nodes to produce the inversion of an individual leaf node.

31. The method of claim 25, further comprising minimizing the disparity among the sizes of the encryption exponents of the public keys within the set.

32. A method for secure communications in a computer network, comprising;
combining individually encrypted network security protection messages into a set of encrypted messages, wherein each encrypted handshake message is derived using a public key containing an encryption exponent;
determining a root node of a binary tree comprising leaf nodes corresponding to each encrypted messages encryption exponent;
calculating a product of the encrypted messages;
minimizing the disparity among the sizes of the encryption exponents of the public keys within the set;
extracting at least one root from the product of the encrypted messages; and
decrypting the encrypted messages by evaluating the at least one leaf node by multiplying an inversion of a total product of the leaf nodes with a partial product of the leaf nodes to produce the inversion of the at least one leaf node wherein efficiency of establishing secure network communications is increased.

33. The method of claim 32, wherein combining includes secure socket layer (“SSL”) messages.

34. The method of claim 32, wherein combining includes transport layer security (“TLS”) messages.

35. The method of claim 32, wherein combining includes internet protocol secure (“IPSec”) messages.

36. A method for secure communications in a computer network, comprising:
coupling a client to a web server;
sending a client hello message to the web server;
generating a public/private key pair at the web server, wherein the public key contains an encryption exponent;
responding to the client with a server hello message comprising the public key;
encrypting a random handshake message at the client using the public key;
sending the encrypted handshake message to a batch-decryption server;
batching handshake messages on a batch-decryption server according to the public key such that the disparity between the sizes of the encryption exponents of the public key is minimized;
separating the batch's e^{th} root in a downward-percolation phase into constituent decrypted messages, wherein internal inversions are converted to modular divisions increasing efficiency by producing a reduced number of modular inversions;
scheduling the batch-decryption server based on server-load considerations;
decrypting the handshake messages using at least one alternate expression of at least on arithmetic function of at least one batch's e^{th} root; and
sending the decrypted message to the web server.

37. The method of claim 36, wherein batching handshake messages includes Secure Socket Layer (“SSL”) messages.

38. The method of claim 36, wherein combining includes transport layer security (“TLS”) messages.

39. The method of claim 36, wherein combining includes internet protocol secure (“IPSec”) messages.

40. The method of claim 36, wherein batching further comprises an upward-percolation phase that combines individual encrypted messages to form a value, v wherein v is the product of the individual encrypted messages raised to the power of e/e₁, e being the product of all individual encryption exponents e₁.

41. The method of claim 36, wherein the value v is determined by the equation
$$v = {\prod }_{i = 1}^{b} {v}_{i}^{e / {e}_{i}} ,$$
where e is the product of individual exponentiation exponents, vᵢ is the individual encrypted message, eᵢ is the individual public key, and b is the number of encrypted messages in a particular batch.

42. The method of claim 36, wherein batching further comprises an exponentiation phase that includes the extraction of an e^{th} root from the value, v.

43. The method of claim 36, wherein exponentiation further includes simultaneous multiple exponentiation such that the encryption exponents are combined to reduce the number of exponentiations.

44. The method of claim 36, wherein exponentiation includes combining a plurality of inversions to form a single modular inversion.

45. The method of claim 36, wherein decrypting includes reducing each encrypted batch message into a separate moduli, using separate parallel batch trees to determine the moduli, and combining the final answers.

46. A method for batch decryption in a computer network comprising:
combining a plurality of encrypted messages into a plurality of batches, wherein each encrypted message includes a public/private key pair, each public key comprising an encryption exponent;
scheduling the batches of encrypted messages using a plurality of criteria selected from a group including maximum throughput, minimum turnaround-time, minimum turnaround-time variance, and server load considerations, wherein the efficiency of establishing secure communications is enhanced; and
replacing at least one inversion of at least one batch decryption operation with a single inversion and a plurality of multiplication operations, wherein the speed of the decryption is significantly improved.

47. The method of claim 46, wherein combining a plurality of encrypted messages includes secure socket layer (“SSL”) messages.

48. The method of claim 46, wherein combining a plurality of encrypted messages includes transport layer security (“TLS”) messages.

49. The method of claim 46, wherein combining includes internet protocol secure (“IPSec”) messages.

50. The method of claim 46, further comprising using separate, parallel batch trees and combining the results.

51. The method of claim 46, wherein combining includes selecting the encrypted messages for the batches by balancing the encryption exponent.

52. A method for secure communications in a computer network, comprising;
combining individually encrypted network security protection handshake messages into a set of encrypted handshake messages wherein each encrypted message is derived using a public key comprising an encryption exponent;
determining a root node of a binary tree containing leaf nodes corresponding to each encrypted message encryption exponent by using a plurality of separate parallel batch trees finding the root node of each tree and combining the final answers;
minimizing the disparity between the sizes of the encryption exponents of the public keys within the set;
using simultaneous multiple exponentiation such that the encryption exponents are combined to reduce the number of exponentiations;
calculating a product of the encrypted messages;
extracting at least one root from the product of the encrypted messages; and
decrypting the encrypted messages by expressing the at least one root as at least one promise and evaluating the at least one promise at the leaf nodes, and multiplying an inversion of a total product of the leaf nodes with a partial product of the leaf nodes decreasing the number of modular inversions by producing an inversion of the leaf node wherein efficiency of secure communications is increased.

53. The method of claim 52, wherein combining encrypted network security protection handshake messages includes secure socket layer (“SSL”) messages.

54. The method of claim 52, wherein combining encrypted network security protection handshake messages includes transport layer security (“TLS”) messages.

55. The method of claim 52, wherein combining encrypted network security protection handshake messages includes internet protocol secure (“IPSec”) messages.

56. A method for performing batch decryption in a computer network, comprising:
receiving a plurality of encrypted messages generated using a plurality of public keys, wherein the plurality of public keys share a common modulus;
forming a binary tree using leaf nodes corresponding to the plurality of public keys;
placing each of the plurality of encrypted messages in a leaf node having a corresponding public key;
percolating the plurality of encrypted messages up the binary tree to form a root node including a product of the encrypted messages, extracting at least one root from the product of the encrypted messages by forming an exponentiation product in the root node;
expressing the at least one root using at least one promise that includes at least one alternative representation of at least one arithmetic function of the at least one root;
percolating the at least one root down the binary tree using the at least one promise; and
decrypting the plurality of encrypted messages by evaluating the at least one promise at the leaf nodes, wherein efficiency of the decryption is increased by reducing a number of modular inversions and a number of root extractions.

57. The method of claim 56, wherein receiving a plurality of encrypted messages includes secure socket layer (“SSL”) messages.

58. The method of claim 56, wherein receiving a plurality of encrypted messages includes transport layer security (“TLS”) messages.

59. The method of claim 56, wherein receiving a plurality of encrypted messages includes internet protocol secure (“IPSec”) messages.

60. The method of claim 56, wherein evaluating the at least one promise uses batched division to calculate a plurality of inverses for the plurality of leaf nodes using a single modular inversion, wherein the single modular inversion is multiplied with a partial product at each leaf node to produce a corresponding inverse for the leaf node

61. The method of claim 56, further comprising:
reducing each of the plurality of encrypted messages modulo p and q;
generating two parallel batch trees modulo p and q; and
batching in each of the two parallel batch trees modulo p and q.

62. The method of claim 56, wherein the percolating includes balanced exponents.

63. The method of claim 56, wherein the percolating includes simultaneous multiple exponentiation.

64. A method for secure communications in a computer network, comprising:
generating a Rivest-Shamir-Adleman (“RSA”) public/private key pair at a web server;
coupling a client to the web server;
sending a client hello message to the web server requesting the establishment of a Secure Socket Layer (“SSL”);
responding to the client with a server hello message containing the RSA public key;
encrypting a random string R, the pre-master secret at the client, using the RSA public key, wherein the resulting cipher-text, C, contains R;
sending the encrypted cipher-text message, C, to the web server;
combining individually encrypted secure socket layer (“SSL”) encrypted cipher-text messages to form a batch;
decrypting the batch of cipher-text, C, messages at the web server using the RSA private keys to determine R, wherein the efficiency of the decryption is enhanced by replacing at least one inversion with at least one multiplication; and
establishing a common session key between the web server and the client using R.

65. The method of claim 64, wherein decrypting includes using at least one alternative representation of at least one arithmetic function to reduce to the number of inversions.

66. A system for secure communications in a computer network comprising:
at least one client processor;
at least one web server; and
at least one batch server coupled among the at least one client processor and the at least one web server, wherein the at least one batch server receives requests for decryption of a plurality of individually encrypted network secure protection handshake messages, aggregates the plurality of individually encrypted handshake messages into at least one batch wherein each encrypted message is derived by using an encryption exponent from an Rivest-Shamir-Adleman (“RSA”) public/private key pair, forms a binary tree containing leaf nodes corresponding to each encryption exponent, extracts at least one root from a product of the encrypted messages, decrypts the encrypted messages by expressing the at least one root as at least one promise and evaluating the at least one promise at the leaf nodes, and multiplies an inversion of a total product of the leaf nodes with a partial product of the leaf nodes producing an inversion of the leaf node decreasing the number of modular inversions, and responds to the requests for decryption with corresponding plain-text.

67. The system of claim 66, wherein the individually encrypted network secure protection handshake messages includes secure socket layer (“SSL”) messages.

68. The system of claim 66, wherein the individually encrypted network secure protection handshake messages includes transport layer security (“TLS”) messages.

69. The method of claim 66, wherein the individually encrypted network secure protection handshake messages includes internet protocol secure (“IPSec”) messages.

70. The system of claim 66, wherein the batch server aggregates the plurality of encrypted messages base on criteria including maximum throughput, minimum turnaround time, and minimum turnaround time variance.

71. A system for secure communications in a computer network, comprising at least one client processor coupled among at least one web server, wherein the web server receives requests for decryption of a plurality of individually encrypted network security protection handshake messages, aggregates the plurality of individually encrypted handshake messages into at least one batch wherein each encrypted message is derived using an encryption exponent from an Rivest-Shamir-Adleman (“RSA”) public/private key pair, forms a binary tree containing leaf nodes corresponding to each encryption exponent, extracts at least one root from a product of the encrypted messages, decrypts the encrypted messages by expressing the at least one root as at least one promise and evaluating the at least one promise at the leaf nodes, and multiplies an inversion of a total product of the leaf nodes with a partial product of the leaf nodes producing an inversion of the leaf node decreasing the number of modular inversions, wherein efficiency of secure communications is increased.

72. A system of scheduling batch decryption in a computer network, comprising:
a plurality of client processors;
at least one web server;
at least one batch server coupled among the at least one web server and the plurality of client processors using a Rivest-Shamir-Adleman (“RSA”) decryption algorithm, wherein the at least one batch server links the plurality of client processors to the at least one web server; and
a scheduler, wherein during a timed period the scheduler places arriving encrypted messages in a queue forming a batch, wherein the encrypted messages in the queue are decrypted upon completion of the timed period.

73. A system for secure network communications in a computer network, comprising at least one batch server coupled among at least one client processor and at least one web server, wherein the at least one batch server uses a Rivest-Shamir-Adleman (“RSA”) batch algorithm to decrypt an aggregation of encrypted messages transferred among the at least one client processor and the at least one web server.

74. A system for secure computer network communications, comprising at least one client processor and at least one server processor wherein the server processor combines decryption requests of Secure Socket Layer (“SSL”) messages into at least one batch and decrypts the at least one batch using a Rivest-Shamir-Adleman (“RSA”) batch decryption algorithm.

75. A computer-readable medium, comprising executable instructions for establishing secure communications in a computer network which, when executed in a processing system, causes the system to:
combine individually encrypted network security protection handshake messages into a set of encrypted messages wherein each encrypted handshake message is derived using a public key comprising an encryption exponent;
determine a root node of a binary tree containing leaf nodes corresponding to each encrypted messages encryption exponent by using a plurality of separate parallel batch trees to find the root node of each tree and combine the final answers;
minimize the disparity between the sizes of the encryption exponents of the public keys within the set;
combine the encryption exponents using simultaneous multiple exponentiation such that the number of exponentiations is reduced;
calculate a product of the encrypted messages;
extract at least one root from the product of the encrypted messages; and
decrypt the encrypted messages by expressing the at least one root as at least one promise and evaluating the at least one promise at the leaf nodes, multiplying an inversion of a total product of the leaf nodes with a partial product of the leaf nodes producing an inversion of the leaf node and decreasing the number of modular inversions, wherein efficiency of establishing secure communications is increased.

76. An electromagnetic medium, comprising executable instructions for establishing secure communications in a computer network which, when executed in a processing system, causes the system to;
combine individually encrypted secure network handshake messages into a set of encrypted handshake messages wherein each encrypted handshake message is derived using a public key comprising an encryption exponent;
determine a root node of a binary tree containing leaf nodes corresponding to each encrypted messages encryption exponent by using a plurality of separate parallel batch trees to find the root node of each tree and combine the final answers;
minimize the disparity between the sizes of the encryption exponents of the public keys within the set;
combine the encryption exponents using simultaneous multiple exponentiation such that the number of exponentiations is reduced;
calculate a product of the encrypted messages;
extract at least one root from the product of the encrypted messages; and
decrypt the encrypted messages by expressing the at least one root as at least one promise and evaluating the at least one promise at the leaf nodes, multiplying an inversion of a total product of the leaf nodes with a partial product of the leaf nodes producing an inversion of the leaf node, and decreasing the number of modular inversions wherein efficiency of establishing secure communications is increased.
